(19) United States
(12) Patent Application Publication
(10) Pub. No.: US 2008/0238188 A1
(43) Pub. Date: Oct. 2, 2008

(54) Method of Modulating Brake Pressures on Motorcycles

(75) Inventors: Dieter Burkhard, Bingen-Budingen (DE); Ralph Gronau, Wetter (DE)

Correspondence Address: CONTINENTAL TEVES, INC., ONE CONTINENTAL DRIVE, AUBURN HILLLS, MI, 48326-1581, US

(73) Assignee: Continental Teves AG & Co. oHG

(21) Appl. No.: 12/064,035

(22) PCT Filed: Aug. 2, 2006
(86) PCT No.: PCT/EP2006/064979

§ 371 Date: Feb. 18, 2008

(30) Foreign Application Priority Data
Aug. 23, 2005 (DE) 102005039975.4
Aug. 2, 2006 (DE) 102006036383.3

(51) Int. Cl. B60T 8/34

(52) U.S. Cl. 303/113.2

(57) ABSTRACT

Disclosed is a method and brake system for modulating brake pressures in a motorcycle brake system with anti-lock function and integral braking function. Inlet and outlet valves (9, 10) are provided in each case for brake slip control in a front-wheel brake circuit (1) and a rear-wheel brake circuit (2). Active pressure buildup in a brake circuit other than the brake circuit actuated by the motorcyclist is performed by the integral braking function using a pump (15) and at least one separating and change-over valve (11, 18) in at least one of the brake circuits (1, 2). In the brake circuit (1, 2) being initiated by the integral function, brake pressure modulation is controlled or regulated using the change-over valve (18) and/or the separating valve (11) during brake slip control.

### BACKGROUND OF THE INVENTION

The present invention relates to a method of modulating brake pressure in a motorcycle brake system with anti-lock function and integral braking function and to a motorcycle brake system performing the method.

In the course of the past decades, the motorcycle developed from a low-cost means of locomotion to a recreational vehicle increasingly placing the safety and the comfort of the driver in the center of attention.

Similar to automobiles a few years ago, motorcycles are also equipped with anti-lock systems (ABS) at an increasing rate. EP 0 548 985 B1 discloses an anti-lock device for motorcycles by way of example. Furthermore, DE 40 00 212 A1 discloses a method for braking a motorcycle by wheel lock protection and for determining the coefficient of friction.

Conventionally, motorcycles have one actuating element for each of the two brake circuits. In most cases the front-wheel brake is actuated using a ‘hand brake lever’, while the rear-wheel brake is actuated by a ‘foot brake lever’.

In connection with motorcycles, an ‘integral brake system’ is understood to be a brake system where the brake of the second brake circuit is initiated additionally for braking intervention when the hand brake lever or the foot brake lever is applied. Thus, actuation of one single actuating element allows activating both brakes. When both brakes are activated upon actuation of the hand and the foot brake levers, this is referred to as full integral brake. However, combinations are also possible where one brake lever acts on one wheel and the other brake lever acts on both wheels (partial integral brake). Integral brake systems for motorcycles are disclosed in DE 38 03 563 A1 and DE 103 16 351 A1, for example.

In motorcycles with an integral function, the actuation of one single actuating element (e.g. hand brake lever and/or foot brake lever) initiates the automatic brake force distribution or the brake pressure distribution between front wheel and rear wheel using either an invariable hydraulic circuit configuration by means of which the brake force distribution is predetermined invariably in a defined ratio, or by way of an electronics used to control the predetermined brake force distribution.

Document JP 2000071963 A discloses a brake system for motorcycles which safeguards the functionality of ABS and integral brake. The brake system includes a hydraulically operable front-wheel and rear-wheel brake circuit in which, jointly or also independently of one another, brake pressure can be built up in the wheel brakes using a foot-operated and hand-operated master brake cylinder. Electromagnetically activatable inlet and outlet valves and a dual-circuit pump drivable by an electric motor are inserted into the front-wheel and rear-wheel brake circuit for brake slip control (e.g. anti-lock function or electronic brake force distribution). Besides, electrically operable separating and change-over valves are provided in both brake circuits in addition to the inlet and outlet valves and the pump in order to build up brake pressure in an electrohydraulic way in the brake circuit which is not operated manually in the event of manual actuation of one of the two master brake cylinders (integral function). To this end, the pump and the separating and change-over valve are activated electrically in the brake circuit which is not operated manually.

It is disadvantageous in this brake system that in a brake slip control operation (e.g. anti-lock function (ABS) or electronic brake force distribution (EBD)) the driver feels a ‘hard’ brake lever in the event of actuation of the hand or foot brake lever which corresponds to that brake circuit which has previously been initiated by the integral function. The reason for this fact is that during brake slip control the pressure modulation is carried out by way of the wheel valves (inlet and outlet valve) and that the inlet valve is closed for the most part during the control so that the driver feels resistance when actuating the brake lever.

In view of the above, an object of the invention is to provide an alternative method of modulating brake pressures in a motorcycle brake system with anti-lock function and with integral braking function which overcomes the above-mentioned drawback.

### SUMMARY OF THE INVENTION

The idea underlying the invention aims at using the change-over and separating valves instead of the inlet and outlet valves to control or regulate, in the case of brake slip control, the brake pressure modulation in the brake circuit which is actively acted upon by brake pressure on account of the integral function.

As a generalization, the term ‘manual’ actuation does not only imply the actuation by hand but also the actuation by foot according to the invention.

According to the invention, critical braking is to be understood as a brake operation where quick brake pressure control is required to ensure safe braking and/or an optimal stopping distance. This can occur by way of example in the event of heavy braking (hazardous braking) or if there is a sudden change in the road's coefficient of friction.

In a preferred embodiment of the method of the invention, brake slip control allows maintaining the brake pressure in the brake circuit which is initiated by the integral function by closing of the change-over valve.

During brake slip control in the brake circuit which is initiated by the integral function, reduction of the brake pressure is preferably achieved by opening the separating valve, and with particular preference by fully opening the separating valve. With an analog valve, it is also particularly preferred that the separating valve is only partly opened.

Buildup of brake pressure which is being performed after the brake pressure has been maintained or reduced is preferred to be realized by closing the separating valve and opening the change-over valve.

Brake slip control with the aid of the change-over valve and/or the separating valve is preferably discontinued and a ‘normal’ brake slip control operation, especially preferred an ABS brake operation, is carried out by way of the inlet and outlet valves when braking is critical.

In another preferred embodiment, critical braking is detected depending on the behavior of the motorcyclist or depending on vehicle operating parameters. In this case, the slip of a wheel is especially preferred to be taken into account, and the slip of the integrally braked wheel with quite particular preference. It is also especially preferred to discontinue brake slip control using the change-over valve and/or the separating valve when the driver manually intervenes into the wheel which has previously been integrally braked or, what is given quite particular preference, is manually intervening to brake intensely so that the wheel passes over into ABS control.

Moreover, the brake slip control in which the change-over valve and/or the separating valve are/is used to control or regulate brake pressure modulation is preferred to be a control for the electronic brake force distribution.

The invention also relates to a motorcycle brake system in which a method as described hereinabove is implemented.

Further preferred embodiments of the invention can be seen in the subsequent description by way of a Figure.

### BRIEF DESCRIPTION OF THE DRAWING

In the accompanying drawing:

FIG. 1 shows a schematic view of an integral brake system of a motorcycle for implementing a method according to the invention.

### DETAILED DESCRIPTION OF THE DRAWING

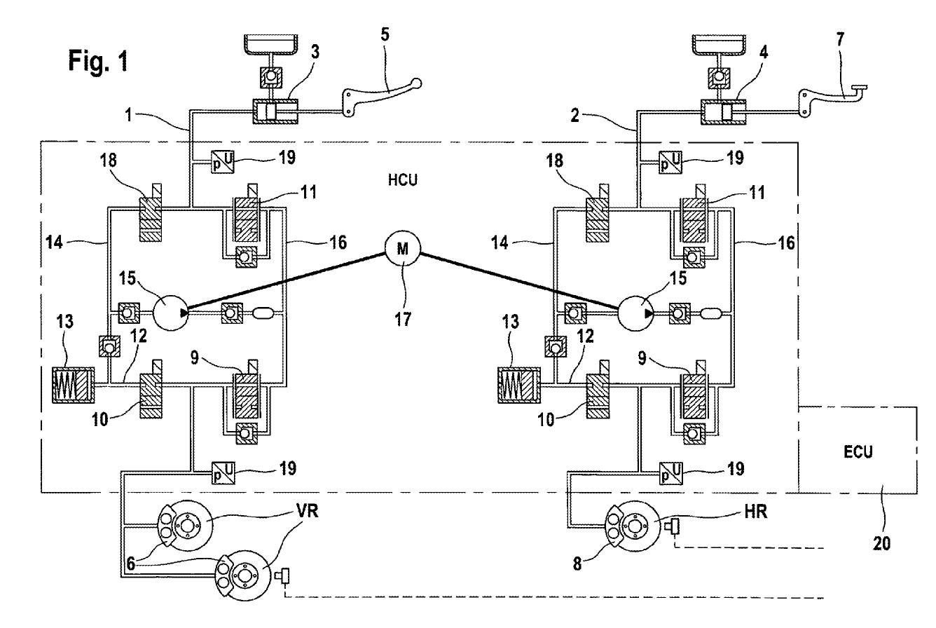

FIG. 1 is a schematic view of an integral brake system for a motorcycle. The brake system comprises two brake circuits 1, 2, one for the front wheel FR and one for the rear wheel RR with respectively one master brake cylinder 3, 4. The driver uses a hand brake lever 5 to directly operate the front-wheel brake 6 and a foot pedal 7 to operate the rear-wheel brake 8.

For brake slip control, electromagnetically operable inlet and outlet valves 9, 10 are arranged in the front-wheel and rear-wheel brake circuits 1, 2, and an inlet valve 9 that is open in its basic position is inserted in each case into the brake line of the front-wheel and rear-wheel brake circuit 1, 2 which connects the respectively associated master brake cylinder 3, 4 to the front-wheel or the rear-wheel brake 6, 8 by way of the separating valve 11 which is open in its basic position. The outlet valve 10 that is closed in its basic position is respectively inserted into a return line 12 of each brake circuit, which connects the front-wheel or rear-wheel brakes 6, 8 to respectively one low-pressure accumulator 13 and to the suction conduit 14 of a dual-circuit pump 15, which operates according to the return principle. On the pressure side, the pump 15 is in connection with the brake lines 16 of both brake circuits so that return delivery of the brake fluid volume discharged in each case from the front-wheel or rear-wheel brake 6, 8 is safeguarded in conformity with requirements in a brake slip control phase. The pump pistons of the two pump circuits are jointly driven by an electric motor 17.

In line with their circuit-related design, both brake circuits 1, 2 can be operated jointly as well as independently of one another, with the particularity that e.g. in the event of a manual operation of the master brake cylinder 3 connected to the front-wheel brake circuit 1, not only brake pressure buildup in the front-wheel brake 6 but simultaneously also electrohydraulic brake pressure buildup in the rear-wheel brake 8 occurs because the electric motor 17 enables the pump 15 as soon as pump 15 removes pressure fluid from the master brake cylinder 4 and conveys it to the rear-wheel brake 8 on account of the electrically initiated open position of the change-over valve 18 in the rear-wheel brake circuit 2, while the separating valve 11 in the rear-wheel brake circuit 2 separates the pump pressure side from the master brake cylinder 4.

It is of course also possible to reverse the above-mentioned example of actuation by triggering an electrohydraulically initiated braking operation on the front-wheel brake 6 according to the same pattern depending on the manual actuation of the master brake cylinder 4 connected to the rear-wheel brake 2. From this follows that upon actuation of one of the two master brake cylinders 3, 4, that brake circuit which is in each case not actuated by the driver is pressurized by the dual-circuit pump 15 in a quasi electrohydraulically independently actuated fashion so that in the event of individual actuation of one of the two master brake cylinders, both brake circuits will always contribute actively to brake deceleration (full integral brake).

Pressure sensors 19 are typically employed to sense the pressures introduced into the brake circuits 1, 2 by the master brake cylinders 3, 4. The two brake circuits 1, 2 additionally comprise two pressure sensors 19 to sense the wheel brake pressure for analog control of the inlet valves 9. To evaluate the pressure sensor signals, a logic circuit is provided in an electronic control unit 20 in which the electrically operable pump 15 is used to generate hydraulic pressure depending on the result of evaluation of the pressure sensor signals.

According to the state of the art, the following applies to pressure modulation within the context of a slip-controlled brake operation (ABS/EBD control):
An imminent locked condition of the front wheel FR or the rear wheel RR is reliably detected by means of wheel speed sensors and their signal evaluation in the control unit 20. The inlet valve 9 arranged in the front-wheel or rear-wheel brake circuit 1, 2 is electromagnetically closed by way of the control unit 20 in order to prevent further pressure buildup on the front-wheel or rear-wheel brake 6, 8, respectively.
If it is desired to additionally decrease the pressure in the front-wheel or rear-wheel brake circuit 1, 2 for reducing the tendency to lock, this aim is achieved by opening the normally closed outlet valve 10 which is connectable to the low-pressure accumulator 13 in each case. The outlet valve 10 is closed as soon as wheel slip rises again beyond a defined rate. The corresponding inlet valve 9 remains closed in the pressure reduction phase so that the master brake cylinder pressure generated in the front-wheel or rear-wheel brake circuit 1, 2 cannot propagate to the front-wheel or rear-wheel brake 6, 8.
When the slip values determined permit again pressure buildup on the front-wheel or rear-wheel brake 6, 8, the inlet valve 9 is being opened in a temporally limited manner corresponding to the demand of the slip controller that is integrated in the control unit 20. The hydraulic volume required for pressure buildup is furnished by the pump 15.

The integral brake system illustrated in FIG. 1 is made the basis for explaining an embodiment of a method of the invention in the following. However, it is also possible to implement the method of the invention in other motorcycle brake systems such as partial integral brake systems. Besides, it shall be assumed in the following for reasons of simplification that the driver actuates the hand brake lever 5 only. However, the exemplary method may be carried out similarly when the foot brake lever 7 or both brake levers is/are actuated.

In conformity with the above statements, in a motorcycle brake system with integral function the brake pressure level at the wheel which is not braked manually by the driver, for example the rear wheel RR, is determined by way of a brake force distribution (stored e.g. in the electronic control unit 20), and a corresponding brake pressure is introduced actively into the rear-wheel brake circuit 2. To this end, pump 15 is used to convey brake fluid from the master cylinder 4 via the open change-over and inlet valve 18, 9 to the rear-wheel brake 8, with the separating and outlet valves 11, 10 closed.

The optimal brake pressure distribution (rear-wheel brake pressure compared to the front-wheel brake pressure) highly depends on the load condition of the vehicle. As it is very difficult to determine the load condition with precision, situations may occur in which the active pressure buildup controlled by the integral braking function causes overbraking of the wheel RR. The result is that brake slip control (ABS and/or EBD) is triggered on this wheel RR. The pressure modulations which are performed corresponding to the state of the art within the context of ABS/EBD control take place by way of the wheel valves (inlet valve 9 and outlet valve 10), as has been described hereinabove.

When the driver intervenes manually into the integrally braked wheel RR during the ABS/EBD control, a ‘hard’ foot brake lever 7 is the result because the inlet valve 9 is closed for the most part during an ABS/EBD control operation. Furthermore, the actuation of the pump 15 (e.g. the rotational speed of the pump) is determined by way of the filling level of the low-pressure accumulators 13 within the context of ABS control. This fact renders it more difficult to exactly dose the pressure buildup by way of the pump 15.

According to the exemplary method (EBD/ABS special control mode), the above-mentioned drawbacks are prevented in that in the brake circuit 2, which is initiated using the integral function, pressure modulation during brake slip control (ABS/EBD control) is carried out only by regulating the change-over and separating valves 18, 19. The inlet valve 9 in the rear-wheel brake circuit remains constantly open in this EBD/ABS special control mode. The outlet valve 10 remains constantly closed so that the corresponding low-pressure accumulator 13 is not filled.

If it is desired in the special control mode to maintain the brake pressure in the rear-wheel brake circuit 2 which is actively initiated by the integral function, the change-over valve 18 is closed by way of example. The active pressure buildup can be limited by observing the slip behavior of the wheel RR. This slip monitoring action is carried out following the EBD principle known from motor vehicles: Accordingly, wheel slip is compared with a threshold and brake pressure buildup is stopped (brake pressure is maintained) when this threshold is reached.

If it is subsequently desired to initiate brake pressure reduction in the rear-wheel brake circuit 2 when an EBD pressure reduction threshold is reached, i.e. when the wheel slip on the rear wheel RR reaches a defined threshold value within the context of the EBD control method, the pressure in the wheel brake 8 is reduced by way of example using the separating valve 11 by opening the latter valve completely or partly. As a result, brake fluid can propagate from the wheel brake 8 through the inlet and separating valve 9, 11 into the master brake cylinder 4. In this case, the separating valve 11 can be a digital valve or an analog valve. Pressure reduction in an analog mode offers the advantage of precise pressure adjustment and great comfort.

It is also possible to control a higher wheel dynamics which causes the ABS entry thresholds to be exceeded by way of pressure reduction using the separating valve 11. The subsequent pressure buildup which is carried out by way of the pump 15 while the separating valve 11 is closed and the change-over valve 18 opened, leads to an ABS control which is low-frequent compared to the ABS control by way of the wheel valves (‘normal’ ABS), and further pressure reduction phase are initiated following the EBD criteria. Pressure reduction is continued using the separating valve 11.

Triggering of a ‘normal’ ABS control operation can be detected because the driver manually intervenes into the rear-wheel brake circuit 2 which is actively initiated by the integral function (e.g. by way of the tandem master cylinder pressure) and will immediately discontinue the EBD/ABS special control mode when the corresponding wheel is in a critical slip situation.

The EBD/ABS special control mode offers the advantage of a low-frequent control having insignificant reactive effects (pendulum motions due to wheel lift moments) on the vehicle, especially when braking while cornering. Furthermore, the driver is always in a position to manually intervene into the integrally controlled wheel by actuating the corresponding brake lever. Another advantage can be seen in the non-filling of the low-pressure accumulator 13 so that the full low-pressure accumulator volume is available in a subsequent ‘normal’ ABS control by means of the inlet and outlet valves.

The EBD/ABS special control mode is used in full integral systems for the rear wheel RR and the front wheel FR or also for only one wheel, e.g. rear wheel RR. In partial integral systems the EBD/ABS special control mode is used for the wheel to which pressure is actively applied by the integral function, e.g. rear wheel RR.

In a preferred embodiment, the special control mode with brake pressure modulation by way of the change-over and separating valves is used only for the control according to EBD thresholds which are lower than the ABS thresholds. Thus, the wheel is kept in the EBD control. Advantageously, comfortable braking intervention is thus rendered possible for the driver. If the system is already in an ABS control operation, further pressure buildup through the separating valves or their non-return valves should be prevented since this can lead to a critical situation. Hence follows that the inlet valves are then required to be closed (‘normal’ ABS control by way of the wheel valves). A sufficient rate of deceleration is achieved by using the special control mode only in the EBD control with its ‘low’ EBD thresholds.

1.-10. (canceled)

11. A motorcycle brake system operable by a motorcyclist,
with an anti-lock function and an integral braking function,
with a front-wheel brake circuit (1) and a rear-wheel brake circuit (2), each brake circuit being equipped with an inlet and an outlet valve (9, 10) for brake slip control,
with a pump for active pressure buildup in a brake circuit currently not actuated by the motorcyclist, the pump being activated by the integral braking function, and
with at least one separating and change-over valve (11, 18) in at least one of the brake circuits (1, 2),
wherein in the brake circuit (1, 2) for which the pump has been activated by the integral function, brake pressure modulation is controlled or regulated in a brake slip control operation using at least one of the following two valves: the change-over valve (18), the separating valve (11).

12. The brake system as claimed in claim 11,
wherein the brake pressure in the brake circuit (1, 2), for which the pump has been activated by the integral function, is modulated based on wheel slip of the wheel in that brake circuit (FR, RR).

13. The brake system as claimed in claim 11,
wherein during brake slip control, the change-over valve (18) is closed to maintain the brake pressure in the brake circuit (1, 2), for which the pump has been activated by the integral function.

14. The brake system as claimed in claim 13,
Wherein, during brake slip control, the separating valve (11) is at least partly opened for reducing the brake pressure in the brake circuit (1, 2), for which the pump has been activated by the integral function.

15. The brake system as claimed in claim 14,
wherein the separating valve (11) is closed and the change-over valve (18) is opened for buildup of brake pressure after the brake pressure has been maintained or reduced.

16. The brake system as claimed in claim 15,
wherein, upon detection of a critical braking situation, the brake pressure modulation through the operation of the change-over valve or the separating valve (11, 18) is discontinued and brake pressure modulation by way of the inlet and outlet valves (9, 10) is performed.

17. The brake system as claimed in claim 16,
wherein a critical braking situation is detected by observing behavior of the motorcyclist.

18. The brake system as claimed in claim 16,
wherein a critical braking situation is detected if the slip of one wheel is in excess of a threshold value which is predetermined within the limits of the anti-lock function.

19. The brake system as claimed in claim 1,
wherein the change-over valve (18) and/or the separating valve (11) modulate the brake pressure for electronic brake force distribution between front wheel and rear wheel.
